(19) United States
(12) Patent Application Publication
(10) Pub. No.: US 2010/0025058 A1
(43) Pub. Date: Feb. 4, 2010

(54) ATTACHMENT ARM REMOVAL AND ACTUATOR STORAGE

(75) Inventors: Joseph F. Carter, East Peoria, IL (US); Matthew R. Kettner, Litchfield, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Clark Equipment Company, West Fargo, ND (US)

(21) Appl. No.: 12/304,544

(22) PCT Filed: Jun. 19, 2007
(86) PCT No.: PCT/US07/71592

§ 371 Date: Jun. 16, 2009

Related U.S. Application Data
(60) Provisional application No. 60/814,845, filed on Jun. 19, 2006.

(51) Int. Cl. E02F 3/85; E02F 3/76; B23P 19/00

(52) U.S. Cl. 172/817; 172/830; 29/426.1

(57) ABSTRACT

An attachment assembly for use with a vehicle includes an arm support assembly and an attachment interface assembly pivotally mounted to the arm support assembly. The attachment interface assembly includes an interface plate configured to accept a work attachment. The attachment interface assembly and interface plate pivots under the influence of respective lift and tilt actuators. The attachment interface assembly is removable from the arm support assembly, and the actuators are pivotable into stowed positions, upon removing a pin that attaches the lift actuator piston rod to the attachment interface assembly, a pin that attaches the tilt actuator piston rod to the interface plate, and a pin that pivotally attaches the attachment interface assembly to the arm support assembly. The pins may be used to secure the actuators in the stowed positions, and an additional clip may be used to secure one or both of the actuators in the stowed position.

### CROSS-REFERENCE TO RELATED APPLICATION

This Application is a Section 371 National Stage Application of International Application No. PCT/US2007/071592, filed Jun. 19, 2007 and published as WO 2007/149878 on 27 Dec. 2007, in English, and this application claims priority to U.S. Provisional Patent Application No. 60/814,845 filed Jun. 19, 2006.

### BACKGROUND

The present invention relates to an attachment assembly usable on a work vehicle. More particularly, the attachment assembly includes actuators and an attachment interface portion. The attachment interface portion is removable from the attachment assembly and the actuators are movable into stowed positions when it is desired to use the vehicle without the functionality of the attachment assembly.

### SUMMARY OF THE INVENTION

The invention provides a method of removing a removable portion of an attachment assembly from a work vehicle, the attachment assembly including the removable portion, a fixed portion, and an actuator mounted between the fixed portion and removable portion. The method comprises the steps of: (a) disconnecting the actuator from the removable portion; (b) decoupling a removable portion from the fixed portion; and (c) while maintaining the actuator mounted to the fixed portion, moving the actuator into a stowed position. In some embodiments, step (a) may include extending the actuator, the method further comprising retracting the actuator after step (a). In some embodiments, a pivot pin pivotably couples the fixed and removable portions of the assembly, and wherein step (b) includes removing the pivot pin. In some embodiments, the method further comprises securing the actuator in the stowed position with the pivot pin after step (c). In some embodiments, step (c) includes pivoting the actuator to a generally vertical orientation. In some embodiments, step (c) includes securing a clip around a portion of the actuator, and resisting movement of the actuator from the stowed position with the clip.

The invention also provides an attachment assembly for use with a vehicle. The attachment assembly comprises an arm support assembly including a first lift actuator mount; an attachment interface assembly pivotally mounted about an arm axis to the arm support assembly, the attachment interface assembly including a second lift actuator mount and an interface plate configured to accept a work attachment; a lift actuator including first and second portions linearly movable with respect to each other; a first pin pivotally coupling the first portion of the lift actuator to the first lift actuator mount; and a second pin pivotally coupling the second portion of the lift actuator to the second lift actuator mount. The lift actuator is pivotable about the first pin between an engaged position in which the second portion of the lift actuator is coupled to the second lift actuator mount with the second pin and actuation of the lift actuator causes pivotal movement of the attachment interface assembly about the arm axis, and a stowed position in which the second pin is removed to decouple the second portion of the lift actuator from the second lift actuator mount.

In some embodiments, the interface plate is pivotable about an interface plate axis; the arm support assembly includes a first tilt actuator mount; and the interface plate includes a second tilt actuator mount; and the assembly further comprises a tilt actuator including first and second portions linearly movable with respect to each other; a third pin pivotally coupling the first portion of the tilt actuator to the first tilt actuator mount; and a fourth pin pivotally coupling the second portion of the tilt actuator to the second tilt actuator mount. The tilt actuator may be pivotable about the third pin between an engaged position in which the second portion of the tilt actuator is coupled to the second tilt actuator mount with the fourth pin and actuation of the tilt actuator causes pivotal movement of the interface plate about the interface plate axis, and a stowed position in which the fourth pin is removed to decouple the second portion of the tilt actuator from the second tilt actuator mount. In some embodiments, the arm support assembly includes a stowing hole into which the second pin is insertable to resist movement of the lift actuator out of the stowed position. In some embodiments, the lift actuator has a generally vertical orientation in the stowed position.

The invention also provides a work vehicle comprising: a frame; an engine supported by the frame; a plurality of ground engaging members supporting the frame and rotatable under the influence of the engine for moving the vehicle; and operator controls for controlling operation of the vehicle. The vehicle also includes an arm support assembly mounted to the vehicle frame and including a first lift actuator mount and a first tilt actuator mount. The vehicle also includes an attachment interface assembly pivotally mounted to the arm support assembly with a first pin that defines an arm pivot axis, the attachment interface assembly including an arm having a second lift actuator mount, and an interface plate pivotally mounted to the arm and having a second tilt actuator mount. The vehicle also includes a lift actuator having a first portion pivotally coupled to the first lift actuator mount and a second portion pivotally coupled to the second lift actuator mount by way of a second pin, such that actuation of the lift actuator causes pivoting of the attachment interface assembly about the arm pivot axis with respect to the arm support assembly. The vehicle also includes a tilt actuator having a first portion pivotally coupled to the first tilt actuator mount and a second portion pivotally coupled to the second tilt actuator mount by way of a third pin, such that actuation of the tilt actuator causes pivoting of the interface plate about the interface plate axis with respect to the arm. The attachment interface assembly is removable from the arm support assembly by removing the second and third pins, pivoting the lift and tilt actuators into stowed positions, and removing the first pin to release the attachment interface assembly from the arm support assembly.

In some embodiments, vehicle further comprises means for retaining the lift and tilt actuators in the stowed positions. In some embodiments, the vehicle further comprises stowing holes in the arm support assembly into which the second and third pins are insertable to retain the lift and tilt actuators in the stowed positions. In some embodiments, the vehicle further comprises a clip for retaining at least one of the lift and tilt actuators in the stowed position. In some embodiments, the vehicle further comprises a groove receiving a portion of at least one of the lift and tilt actuators in the stowed position, and a clip retaining the portion in the groove. In some embodiments, the lift and tilt actuators are vertically oriented in the stowed positions. In some embodiments, the first portion of each of the lift and tilt actuators includes a barrel; the second portion of each of the lift and tilt actuators includes a piston rod; the first actuator is pivoted downwardly to position the first actuator piston rod below the first actuator barrel in the stowed position; and the second actuator is pivoted upwardly to position the second actuator piston rod above the second actuator barrel in the stowed position. In some embodiments the vehicle may include a hydraulic pump driven by the engine to create a flow of hydraulic fluid; wherein the lift and tilt actuators include hydraulic actuators that operate in response to the flow of hydraulic fluid. In some embodiments, the lift and tilt actuators include electric actuators.

Other aspects of the invention will become apparent by consideration of the detailed description and accompanying drawings.

### BRIEF DESCRIPTION OF THE DRAWINGS

FIG. 1 is a perspective view of a utility vehicle having an attachment assembly.

FIG. 2 is a perspective view of the attachment assembly.

FIG. 3 is a perspective view of an attachment interface assembly portion of the attachment assembly.

FIG. 4 is an enlarged perspective view of a front portion of the vehicle with the attachment assembly positioned for removal from the vehicle.

FIG. 5 is an enlarged perspective view of the front portion of the vehicle with the actuators in stowed positions.

FIG. 6 illustrates a method of removing the attachment interface assembly from the utility vehicle of FIG. 1.

### DETAILED DESCRIPTION

The present invention is described in the context of a self-propelled, wheeled utility vehicle. However, it should be noted that the present invention can be used in connection with other types of work vehicles other than utility vehicles. For example, the present invention can be used in an all terrain vehicle or other types of small work vehicles.

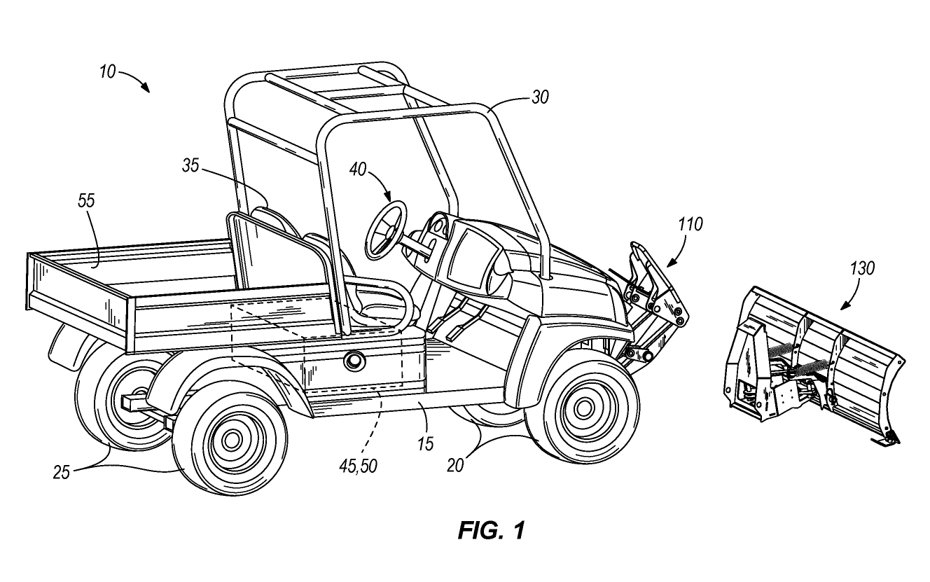

FIG. 1 illustrates a perspective view of an exemplary utility vehicle 10. The utility vehicle 10 includes a frame 15 supported with front and rear wheel assemblies 20, 25 respectively. For the sake of clarity, the terms front, rear, left, and right are used herein with reference to the perspective of an operator seated in the vehicle 10 and facing forward. The frame 15 supports a cab 30 that includes a seat 35 and operator controls 40. The frame 15 also supports an engine 45, which in the illustrated embodiment is disposed between the seat 35 and the rear wheel assembly 25. The engine 45 drives a hydraulic system 50 which includes a hydraulic pump for the provision of a flow of hydraulic fluid. The engine 45 can power either or both of the wheel assemblies 20, 25 through mechanical drives, hydraulic motors or other suitable devices for power transmission. The wheel assemblies 20, 25 can include suspension systems coupled to the frame 15. A steering linkage can be coupled to the front wheels 20, rear wheels 25, or both. In other embodiments, the front and rear wheel assemblies 20, 25 may be replaced with tracks or other ground engaging members. The frame 15 also supports a cargo area 55, which is disposed behind the seat 35 in the illustrated embodiment. Mounted to a front portion of the frame 15 (which may be a portion of increased strength in the frame 15 to resist bending) is an attachment assembly 110.

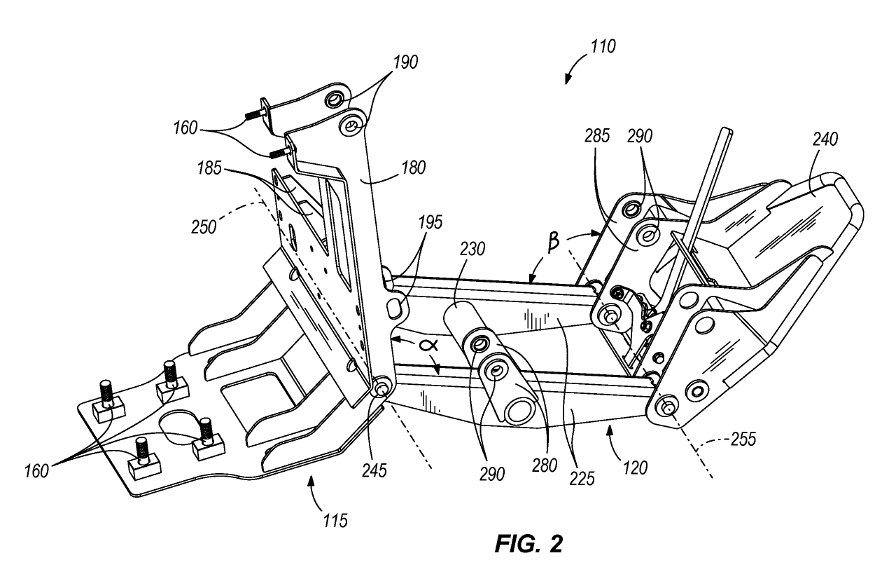

FIG. 2 is a more detailed view of the attachment assembly 110, which includes an arm support assembly 115 and an attachment interface assembly 120. The arm support assembly 115 is intended to remain mounted on the vehicle 10 whether or not the vehicle is using a front-mounted tool, but the attachment interface assembly 120 is removable from the arm support assembly 115 to reduce the overall length of the vehicle 10 and increase its maneuverability when no tool is intended to be mounted to the front of the vehicle 10. In this regard, the arm support assembly 115 may be termed a fixed portion of the assembly 110 and the attachment interface assembly 120 may be termed a removable portion of the assembly 110. An exemplary tool 130 in the form of a blade is illustrated in FIG. 1, but in other embodiments the tool may take the form of buckets, grapples, brooms, augers, pallet forks and many other attachments and tools known in the industry.

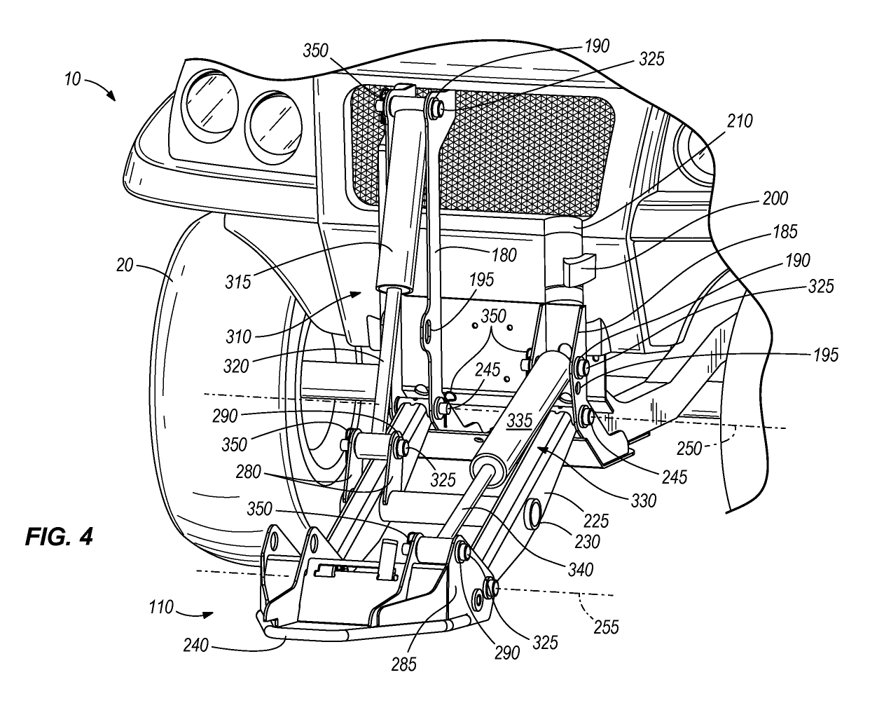

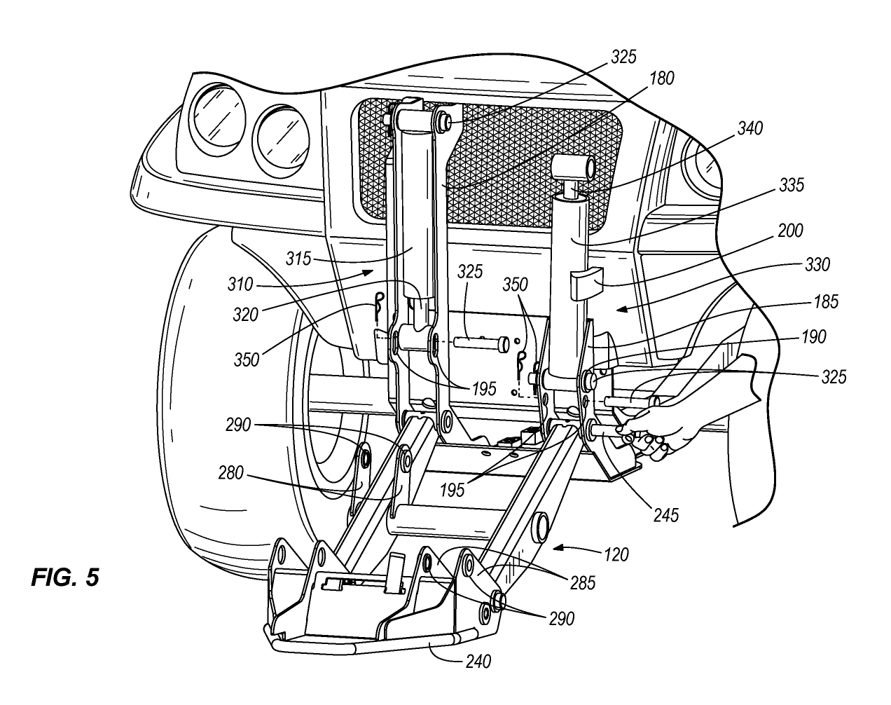

The arm support assembly 115 is configured to be attached to the front portion of the vehicle frame 15, for example, with a plurality of fasteners 160. The arm support assembly 115 includes a first lift cylinder or actuator mount 180 on one side (i.e., right side in the illustrated embodiment) and a first tilt cylinder or actuator mount 185 on the opposite side (i.e., left side in the illustrated embodiment). The first lift and tilt cylinder mounts 180, 185 are illustrated from an opposite perspective in FIGS. 4 and 5, and include ears, brackets, or sidewalls that define a vertically-extending channel or space between them. The first lift cylinder mount 180 and the first tilt cylinder mount 185 each include a pair of coaxial, spaced apart mounting holes having bushings 190 and a pair of coaxial, spaced apart stowing holes or slots 195 in the ears on opposite sides of the channel. In each case, the stowing holes 195 are below the mounting holes 190. The first tilt cylinder mount 185 also includes a stowing clip 200 (FIG. 4) above the mounting and stowing holes 190, 195. The stowing clip 200 may be mounted to the front of the vehicle 10 separately from the first tilt cylinder mount 185 or may be part of the first tilt cylinder mount 185. A generally vertical channel or groove 210 (FIG. 4) may also be provided in front of the vehicle or in the first tilt cylinder mount 185.

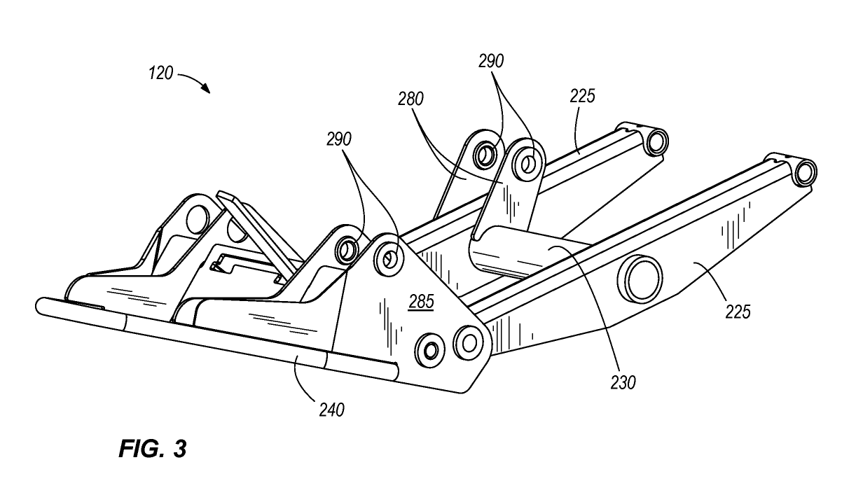

With reference to FIGS. 2 and 3, the attachment interface assembly 120 includes a pair of arms 225, a crossbar 230, and an interface plate 240. The crossbar 230 increases the structural rigidity of the attachment interface assembly 120 by cross-bracing between the arms 225. The arms 225 are pivotally attached at one end to the arm support assembly 115 with support pins 245 that define an arm pivot axis 250, and at the opposite end to the interface plate 240 about an interface plate pivot axis 255. The interface plate 240 is adapted to receive a removable tool (e.g., the blade 130 illustrated in FIG. 1).

Rigidly mounted to or integral with one of the arms 225 of the attachment interface assembly 120 (i.e., the arm 225 on the same side of the attachment assembly 110 as the first lift cylinder mount 180) is a second lift cylinder or actuator mount 280, and rigidly mounted to or integral with the interface plate 240 (on the same side of the attachment assembly 110 as the first tilt cylinder mount 185) is a second tilt cylinder or actuator mount 285. The second lift cylinder mount 280 and the second tilt cylinder mount 285 each include ears, brackets, or sidewalls that include a pair of coaxial, spaced apart mounting holes with bushings 290. The mounting holes with bushings 190, 290 of the arm support assembly 115 and attachment interface assembly 120 provide bearing surfaces for pins, as will be discussed in more detail below.

Referring now to FIG. 4, a lift actuator 310 includes a barrel 315 and a piston rod 320. In the illustrated embodiment, the lift actuator barrel 315 is positioned in the space or channel between the ears of the first lift cylinder mount 180. A pin 325 extends through a cross bore in an end of the barrel 315 and the bushings 190 in the first lift cylinder mount 180 to pivotally couple the retain the lift actuator 310 to the first lift cylinder mount 180. The piston rod 320 is positioned between the ears of the second lift cylinder mount 280 with a similar pin 325 extending through a cross bore in a rod end portion of the piston rod 320 and the coaxial holes and bushings 290 of the second lift cylinder mount 280. A tilt actuator 330 includes a barrel 335 and a piston rod 340 likewise pinned with similar pins 325 to the coaxial mounting holes with bushings 190, 290 in the respective first and second tilt cylinder mounts 185, 285. A catch such as the illustrated cotter pin 350 or a rue ring, snap ring or other similar devices can be used to resist the pins 325 sliding out of the associated mounting holes with bushings 190, 290.

In the illustrated embodiment, the lift and tilt actuators 310, 330 are hydraulically actuated cylinders that are part of the hydraulic system 50 driven by the vehicle engine 45. The actuators 310, 330 may be termed linear actuators having first and second portions that are linearly movable with respect to each other. The hydraulic system 50 provides a flow of hydraulic fluid to the actuators 310, 330 to cause the piston rods 320, 340 to selectively (e.g., in response to operator manipulation of the operator controls 40) extend and retract with respect to the barrels 315, 335. Extending and retracting the piston rod 320 of the lift actuator 310 with respect to the barrel 315 causes the attachment interface assembly 120 to pivot about the arm pivot axis 250, which results in respective increasing and decreasing of the angle α (FIG. 2) between the arm support assembly 115 and the attachment interface assembly 120. When the included angle α increases, the attachment interface assembly 120 is said to lower and when the included angle α decreases, the attachment interface assembly 120 is said to raise.

Extending and retracting the piston rod 340 of the tilt actuator 330 with respect to the barrel 335 causes the interface plate 240 to pivot about the pivot plate axis 255, which results in respective increasing and decreasing of the angle β (FIG. 2) between the interface plate 240 and the arms 225. When the included angle β increases, the interface plate 240 (and any tool attached thereto) is said to dump or pivot forward and when the included angle β decreases, the interface plate 240 (and any tool 260 attached thereto) is said to roll back, curl, or pivot backward.

In other embodiments, the actuators 310, 330 may be attached in the opposite sense, with the piston rods 320, 340 pinned at the first mounts 180, 185 and the barrels 315, 335 pinned at the second mounts 280, 285. Also, other embodiments can employ geometries and linkages through which extending the rods 320, 340 results in raising and curling while retracting the rods 320, 340 results in lowering and dumping. Also, in other embodiments, the lift and tilt actuators may be electric actuators that include electric motors operating in response to alternating or direct current provided by a power source such as a generator or alternator driven off the engine 45 or stored in a battery or the like.

With reference to FIG. 5, the lift and tilt actuators 310, 330 may be moved into the illustrated stowed positions (the positions illustrated in FIG. 4 being engaged positions) with the following sequence of steps. First the actuators 310, 330 are extended to rest the arms 225 on a support surface, such as the ground, with the interface plate 240 pivoted forward. Then the catches 350 and pins 325 are removed from the rod ends (i.e., at the second lift and tilt cylinder mounts 280, 285), and the piston rods 320, 340 are fully retracted into the barrels 315, 335.

Then the lift cylinder 310 is pivoted down about the pin 325 in the first lift cylinder mount 180 and the tilt cylinder 330 is pivoted up about the pin 325 in the first tilt cylinder mount 185, such that both cylinders 310, 330 extend generally vertically across the front of the vehicle 10. The lift cylinder 310 is secured against the first lift cylinder support 180 by inserting the pin 325 (formerly attaching the piston rod 320 to the second lift cylinder mount 280) through the stowing holes 195 holes in the first lift cylinder mount 180. The tilt cylinder 330 is secured against the front of the vehicle 10 or the arm support assembly 115 in the groove 210 by engaging the stowing clip 200 around a portion of the barrel 335, and inserting the pin 325 (formerly attaching the piston rod 340 to the second tilt cylinder mount 285) through the stowing holes 195 in the first tilt cylinder mount 185. The pin 325 engages the bottom of the barrel 335 to resist pivoting of the tilt cylinder 330 downwardly out of the stowed position.

With the actuators 310, 330 stowed, the operator may remove the pins 245 to drop the attachment interface assembly 120 from the arm support assembly 115 and vehicle 10. FIG. 5 illustrates an operator pulling one of the pins 245 out of the assembly 110. The vehicle 10 is now more compact and maneuverable because it does not include the attachment interface assembly 120 in front.

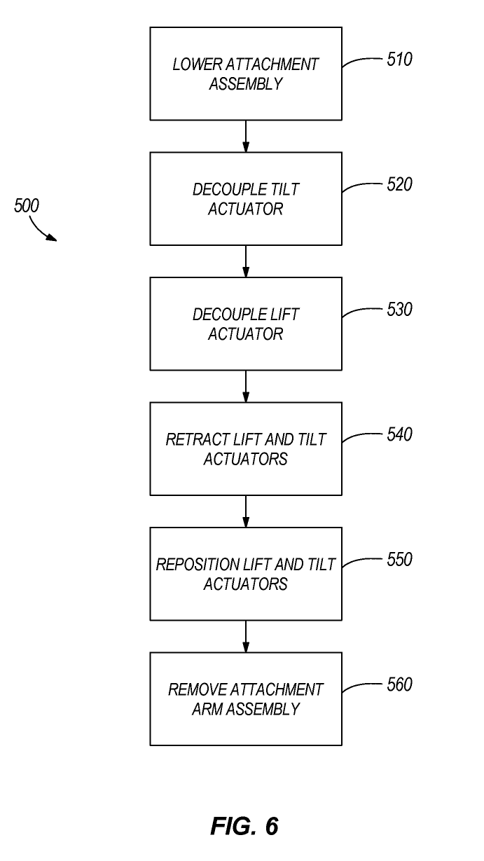

FIG. 6 illustrates a method 500 for removing the attachment interface assembly 120 from the arm support portion 115 of the utility vehicle 10. In block 510, the operator manipulates the operator controls 40 to actuate the lift and tilt actuators 310, 330 to lower the attachment interface assembly 120 and interface plate 140 until the attachment interface assembly 120 and interface plate 140 are fully lowered and pivoted forward. In block 520, pin 325 is removed from the rod end of the tilt actuator 330. Thus, the tilt actuator 330 is now disengaged from the interface plate 140 and the interface plate 140 is free to rotate forward and engage a support surface such as the ground if it is not already supported.

At block 530, the pin 325 is removed from the rod end of the lift actuator 310, thereby de-coupling the lift actuator 310 from the attachment interface assembly 120. The attachment interface assembly 120 is then free to pivot about arm pivot axis 250 toward a support surface such as the ground, if it is not already supported. At block 540, the lift and tilt actuators 310, 330 are fully retracted by manipulating operator controls 40.

At block 550, the lift and tilt actuators 310, 330 are rotated about the pivot points in their respective bases 180, 185 so that they are positioned adjacent the arm support portion 115 of utility vehicle 10 in the channels or grooves provided by the first lift and tilt cylinder mounts 180, 185. When the lift and tilt actuators 310, 330 are fully rotated toward the arm support portion 115, each of the actuators 310, 330 is secured to the arm support portion 115 at an additional location to prevent the lift and tilt actuators 310, 330 from moving when the utility vehicle 10 is being operated. In one embodiment, for example the tilt cylinder 330 is engaged by the latch 200. In addition, retaining pins such as pins 325 can be extended through the stowing holes 195 in the arm support portion 115 to secure the lift and tilt actuators 310, 330. Hydraulic hoses, which are coupled to each of the lift and tilt actuators 310, 330, provide hydraulic oil that causes the rod end of the actuators 310, 330 to extend or retract. Because the hydraulic hoses are flexible, they are able to rotate with the lift and tilt cylinders 310, 330 and are positioned adjacent the lift and tilt cylinders 310, 330 when the lift and tilt cylinders 310, 330 are secured.

In block 560, the retaining pins 245 are then removed from the proximal end of the attachment interface assembly 120 to completely disengage the attachment interface assembly 120 from the arm support portion 115 at the arm pivot axis 250. The retaining pins 245 can be re-inserted into the arm pivot axis 250 to store the pins. While method 500 describes a method of removing the attachment assembly 110, it is to be understood that performing the aforementioned steps substantially in reverse, the attachment assembly 110 can be attached to the utility vehicle 10. For example, the attachment interface assembly 120 can be aligned with the arm support portion 115 at the pivot axis 250 and pins 245 can be reinserted into the arm support portion 115 and the attachment interface assembly 120 to reconnect the attachment interface assembly 120, then the actuators 310, 330 can be pivoted into the engaged positions, extended, and pinned in place at the second mounts 280, 285.

Although the present invention has now been described with reference to preferred embodiments, workers skilled in the art will recognize that changes may be made in form and detail without departing from the spirit and scope of the invention.

1. A method of removing a removable portion of an attachment assembly from a work vehicle, the attachment assembly including the removable portion, a fixed portion, and an actuator mounted between the fixed portion and removable portion, the method comprising the steps of:
(a) disconnecting the actuator from the removable portion;
(b) decoupling a removable portion from the fixed portion; and
(c) while maintaining the actuator mounted to the fixed portion, moving the actuator into a stowed position.

2. The method of claim 1, wherein step (a) includes extending the actuator, the method further comprising retracting the actuator after step (a).

3. The method of claim 1, wherein a pivot pin pivotably couples the fixed and removable portions of the assembly, and wherein step (b) includes removing the pivot pin.

4. The method of claim 3, further comprising securing the actuator in the stowed position with the pivot pin after step (c).

5. The method of claim 1, wherein step (c) includes pivoting the actuator to a generally vertical orientation.

6. The method of claim 1, wherein step (c) includes securing a clip around a portion of the actuator, and resisting movement of the actuator from the stowed position with the clip.

7. An attachment assembly for use with a vehicle, the attachment assembly comprising:
an arm support assembly including a first lift actuator mount;
an attachment interface assembly pivotally mounted about an arm axis to the arm support assembly, the attachment interface assembly including a second lift actuator mount and an interface plate configured to accept a work attachment;
a lift actuator including first and second portions linearly movable with respect to each other;
a first pin pivotally coupling the first portion of the lift actuator to the first lift actuator mount; and
a second pin pivotally coupling the second portion of the lift actuator to the second lift actuator mount;
wherein the lift actuator is pivotable about the first pin between an engaged position in which the second portion of the lift actuator is coupled to the second lift actuator mount with the second pin and actuation of the lift actuator causes pivotal movement of the attachment interface assembly about the arm axis, and a stowed position in which the second pin is removed to decouple the second portion of the lift actuator from the second lift actuator mount.

8. The assembly of claim 7, wherein the interface plate is pivotable about an interface plate axis; wherein the arm support assembly includes a first tilt actuator mount; and wherein the interface plate includes a second tilt actuator mount; the assembly further comprising:
a tilt actuator including first and second portions linearly movable with respect to each other;
a third pin pivotally coupling the first portion of the tilt actuator to the first tilt actuator mount; and
a fourth pin pivotally coupling the second portion of the tilt actuator to the second tilt actuator mount;
wherein the tilt actuator is pivotable about the third pin between an engaged position in which the second portion of the tilt actuator is coupled to the second tilt actuator mount with the fourth pin and actuation of the tilt actuator causes pivotal movement of the interface plate about the interface plate axis, and a stowed position in which the fourth pin is removed to decouple the second portion of the tilt actuator from the second tilt actuator mount.

9. The assembly of claim 7, wherein the arm support assembly includes a stowing hole into which the second pin is insertable to resist movement of the lift actuator out of the stowed position.

10. The assembly of claim 7, wherein the lift actuator has a generally vertical orientation in the stowed position.

11. A work vehicle comprising:
a frame;
an engine supported by the frame;
a plurality of ground engaging members supporting the frame and rotatable under the influence of the engine for moving the vehicle;
operator controls for controlling operation of the vehicle;
an arm support assembly mounted to the vehicle frame and including a first lift actuator mount and a first tilt actuator mount;
an attachment interface assembly pivotally mounted to the arm support assembly with a first pin that defines an arm pivot axis, the attachment interface assembly including an arm having a second lift actuator mount, and an interface plate pivotally mounted to the arm and having a second tilt actuator mount;
a lift actuator having a first portion pivotally coupled to the first lift actuator mount and a second portion pivotally coupled to the second lift actuator mount by way of a second pin, such that actuation of the lift actuator causes pivoting of the attachment interface assembly about the arm pivot axis with respect to the arm support assembly; and
a tilt actuator having a first portion pivotally coupled to the first tilt actuator mount and a second portion pivotally coupled to the second tilt actuator mount by way of a third pin, such that actuation of the tilt actuator causes pivoting of the interface plate about the interface plate axis with respect to the arm;
wherein the attachment interface assembly is removable from the arm support assembly by removing the second and third pins, pivoting the lift and tilt actuators into stowed positions, and removing the first pin to release the attachment interface assembly from the arm support assembly.

12. The vehicle of claim 11, further comprising means for retaining the lift and tilt actuators in the stowed positions.

13. The vehicle of claim 11, further comprising stowing holes in the arm support assembly into which the second and third pins are insertable to retain the lift and tilt actuators in the stowed positions.

14. The vehicle of claim 11, further comprising a clip for retaining at least one of the lift and tilt actuators in the stowed position.

15. The vehicle of claim 11, further comprising a groove receiving a portion of at least one of the lift and tilt actuators in the stowed position; and a clip retaining the portion in the groove.

16. The vehicle of claim 11, wherein the lift and tilt actuators are vertically oriented in the stowed positions.

17. The vehicle of claim 11, wherein the first portion of each of the lift and tilt actuators includes a barrel; wherein the second portion of each of the lift and tilt actuators includes a piston rod; wherein the first actuator is pivoted downwardly to position the first actuator piston rod below the first actuator barrel in the stowed position; and wherein the second actuator is pivoted upwardly to position the second actuator piston rod above the second actuator barrel in the stowed position.

18. The vehicle of claim 11, further comprising a hydraulic pump driven by the engine to create a flow of hydraulic fluid; wherein the lift and tilt actuators include hydraulic actuators that operate in response to the flow of hydraulic fluid.

19. The vehicle of claim 11, wherein the lift and tilt actuators include electric actuators.
